(19) United States
(12) Patent Application Publication
(10) Pub. No.: US 2024/0288173 A1
(43) Pub. Date: Aug. 29, 2024

(54) MANIPULATOR AND HOME APPLIANCE INCLUDING MANIPULATOR

(71) Applicant: LG ELECTRONICS INC., Seoul (KR)

(72) Inventor: Yeong Jun Jo, Seoul (KR)

(21) Appl. No.: 18/405,011

(22) Filed: Jan. 5, 2024

(30) Foreign Application Priority Data
Feb. 24, 2023 (KR) 10-2023-0025352

(51) Int. Cl. F24C 3/12; F24C 7/08; H01H 19/14

(52) U.S. Cl. CPC F24C 3/124; F24C 7/082; H01H 19/14

(57) ABSTRACT

A home appliance is provided that may include at least one knob that is turned to generate a device operating signal related to an operation of at least one heat source, and a knob setting switch configured to manipulated separately from the at least one knob to generate a knob operating signal. The knob may be turned while the knob operating signal is generated to generate the device operating signal.

### CROSS-REFERENCE TO RELATED APPLICATION(S)

This application claims priority to and the benefit of Korean Patent Application No. 10-2023-0025352, filed in Korea on Feb. 24, 2023, the disclosure of which is incorporated herein by reference in its entirety.

### BACKGROUND

### 1. Field

A manipulator, and more specifically, a manipulator having a knob for controlling an operation of a heat source, and a home appliance including a manipulator are disclosed herein.

### 2. Background

A cooking appliance is a type of home appliance for cooking food or other items (hereinafter, collectively “food”) and is installed in a kitchen space to cook the food based on an intention of a user. Such a cooking appliance may be classified in various ways depending on a heat source used, a shape, and a type of fuel, for example.

When classifying the cooking appliance based on a type of cooking the food, the cooking appliance may be classified into an open cooking appliance and a closed cooking appliance depending on a shape of a space in which the food is placed. The closed cooking appliance may include an oven, or a microwave, for example, while the open cooking appliance may include a cooktop, or a hob, for example.

The closed cooking appliance is a cooking appliance that shields the space in which the food is located and cooks the food by heating the shielded space. In addition, the open cooking appliance is a cooking appliance that cooks the food by heating the food or a food container located in an open space.

In the closed cooking appliance, a cooking chamber, which is the space in which the food is placed, is provided. Such cooking chamber is a space that is shielded when the food is cooked and becomes a space where the food is actually cooked. The heat source, such as a heater or a burner, may be disposed in an interior or exterior space of the cooking chamber, and such a heat source may heat the cooking chamber.

Recently, a complex cooking appliance has been proposed that may cook a variety of foods at the same time, as a closed cooking appliance and an open cooking appliance are installed at the same time and a plurality of heat sources are combined with each other. In the complex cooking appliance, the open cooking appliance is located on top of the closed cooking appliance. Additionally, the open cooking appliance may be equipped with a plurality of heat sources, such as the burner, the heater, or a working coil for induction heating, for example. When using the oven for barbecuing, or baking, for example, and grilling meat or fish, the user cooks the food using the closed cooking appliance, and when cooking general dishes by heating the food in a container, the user cooks the food using the open cooking appliance that is exposed at the top.

There are several ways to adjust thermal power of the heat source, such as the burner, the heater, or the working coil. Among those, a scheme using a knob that turns around a predetermined axis is widely used. In the scheme using the knob, the thermal power of the heat source may be adjusted by adjusting an amount of turning of the knob.

For example, a structure in which the knob mechanically adjusts the thermal power of the heat source may be applied to the burner. In the structure in which the knob mechanically adjusts the thermal power of the heat source, the knob may be mechanically connected to a valve that controls a flow amount of gas to mechanically adjust an opening and closing amount of the valve.

As another example, a structure in which the knob electronically adjusts the thermal power of the heat source may be applied to the heat source such as the heater or the working coil. In the structure in which the knob electronically adjusts the thermal power, a scheme of electronically measuring the amount of turning of the knob and adjusting the thermal power of the heat source based on the measured result may be applied.

In the structure in which the knob electronically adjusts the thermal power of the heat source, an operation of the knob to operate the heat source may be performed in two steps. In other words, the operation of the heat source may be started by the two-step manipulation of pressing and then turning the knob.

Typically, the knob is disposed at an upper side of a front surface of the cooking appliance. There is a risk that the knob disposed at such location may be manipulated by being pressed unintentionally by the user. In other words, the knob may be unintentionally manipulated by a user's mistake, or a child's play, for example, which causes the cooking appliance to operate unnecessarily, increasing a risk of fire and increasing a risk of the user suffering injuries, such as burns.

### BRIEF DESCRIPTION OF THE DRAWINGS

Embodiments will be described in detail with reference to the following drawings in which like reference numerals refer to like elements, and wherein:

FIG. 1 is a front perspective view of a home appliance according to an embodiment;

FIG. 2 is a front view of a control panel shown in FIG. 1 according to an embodiment;

FIG. 3 is an enlarged view of a portion of the control panel shown in FIG. 2;

FIG. 4 is a schematic diagram of a home appliance according to an embodiment;

FIG. 5 is a flowchart of an operation control process of a home appliance according to an embodiment;

FIG. 6 is a front view of a control panel disposed in a home appliance according to another embodiment;

FIG. 7 is a flowchart of an operation control process of a home appliance according to another embodiment;

FIG. 8 is a front view of a control panel disposed in a home appliance according to still another embodiment; and

FIG. 9 is a flowchart of an operation control process of a home appliance according to still another embodiment.

### DETAILED DESCRIPTION

Embodiments will be described hereinafter with reference to the attached drawings, so that those skilled in the art in the technical field to which the embodiments belong may easily implement the technical ideas of the embodiments. In describing the embodiments, when it is determined that description of the publicly known technology related to the embodiments may unnecessarily obscure the gist, the description has been omitted. Hereinafter, embodiments will be described with reference to the attached drawings. In the drawings, identical reference numerals are used to indicate identical or similar components.

Although first, second, for example are used to describe various components, these components are not limited by such terms. Such terms are only used to distinguish one component from another component, and unless specifically stated to the contrary, a first component may also be a second component.

The embodiments may not be limited to embodiments disclosed below, and various changes may be made and the embodiments may be implemented in various different forms. The embodiments are provided solely to ensure that the disclosure is complete and to fully inform those skilled in the art of the scope. Therefore, it should be understood that the embodiments are not limited to the embodiments disclosed below, but includes all changes, equivalents, or substitutes included in the technical idea and the scope, as well as substitution of components of one embodiment with components of another embodiment and addition of components.

The attached drawings are only for easy understanding of the embodiments disclosed herein, and the technical ideas disclosed herein are not limited by the attached drawings. Further, it should be understood that the embodiments includes all modifications, equivalents, or substitutions that fall within the technical concept and scope. In drawings, components may be expressed exaggeratedly large or small in size or thickness for convenience of understanding for example, but the scope of protection should not be interpreted as limited by the same.

The terms used herein are merely used to describe specific implementations or embodiments, and are not intended to be limiting. Further, singular expressions include plural expressions, unless the context clearly dictates otherwise. Herein, terms such as “include”, “composed of”, for example are intended to indicate the existence of features, numbers, steps, operations, components, parts, or combinations thereof described herein. In other words, it should be understood that terms such as “include”, “composed of”, for example as used herein do not exclude in advance the presence or addition of one or more other features, numbers, steps, operations, components, parts, or combinations thereof.

Terms including ordinal numbers, such as first, second, for example, may be used to describe various components, but the components are not limited by the terms. The above terms are used only for the purpose of distinguishing one component from another.

When a first component is described as being “connected” or “coupled” to a second component, it should be understood that the components may be directly connected or coupled to each other, but a third component may be interposed between the components. On the other hand, when it is described that the first component is “directly connected” or “directly coupled” to the second component, it should be understood that there are no other components interposed therebetween.

When a first component is described to be “on top of” or “under” a second component, it is understood that the first component may be disposed in contact with a top surface (or a bottom surface) of the second component, as well as a third component may be interposed therebetween.

Unless otherwise defined, all terms used herein, including technical or scientific terms, have the same meaning as commonly understood by a person of ordinary skill in the technical field to which the embodiments pertain. Terms defined in commonly used dictionaries should be interpreted as having a meaning consistent with the meaning in the context of the related technology, and unless explicitly defined herein, should not be interpreted in an ideal or excessively formal sense.

When a home appliance is placed on the floor, a side on which a door is installed, relative to a center of the home appliance is defined as a front side. Therefore, a direction of opening the door and entering the home appliance becomes a rearward direction. For convenience, a direction between the front side and a rear side may be referred to as a first direction. Then, the front side may be referred to as a first side in the first direction, and the rear side may be referred to as a second side in the first direction.

Additionally, the direction of gravity may be defined as a downward direction, and a direction opposite to the direction of gravity may be defined as an upward direction.

In addition, a horizontal direction orthogonal to the frontward and rear ward direction of the home appliance, that is, a widthwise direction of the home appliance when viewing the home appliance in front of the door thereof, may be referred to as a leftward and rightward or lateral direction. For convenience, the leftward and rightward direction may be referred to as a second direction. Then, a right side of the home appliance may be referred to as a first side in the second direction, and a left side may be referred to as a second side in the second direction.

In addition, a widthwise direction of the home appliance may be referred to as a lateral direction. Then, a right side may be referred to as a first side in the lateral direction, and a left side may be referred to as a second side in the lateral direction.

In addition, the vertical direction described above may be referred to as a third direction. Then, an upper side may be referred to as a first side in the third direction, and a lower side may be referred to as a second side in the third direction.

Additionally, the vertical direction described above may be referred to as a heightwise direction. Then, the frontward and rearward direction and the leftward and rightward direction, that is, the first direction and the second direction may be referred to as a transverse direction.

Herein, “A and/or B” means A, B, or A and B, unless otherwise specified, and “C to D” means equal to or greater than C and equal to or smaller than D unless otherwise specified.

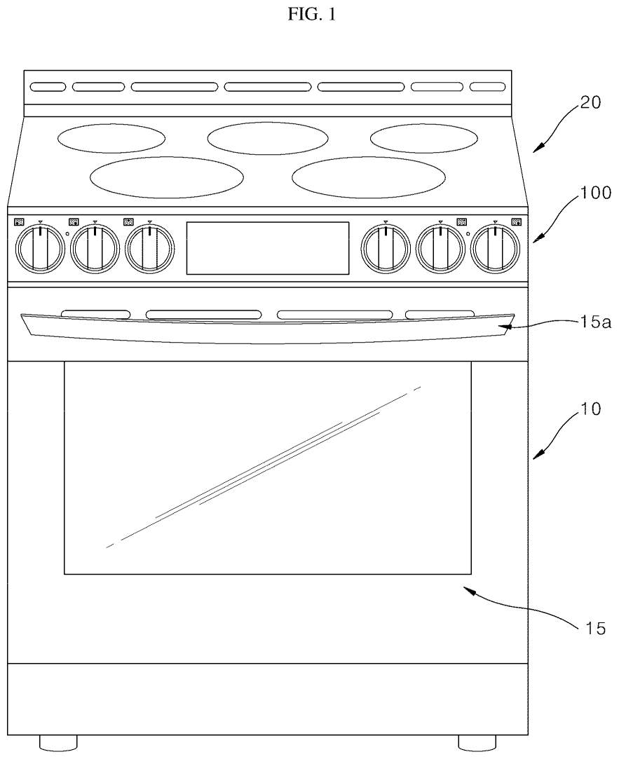

FIG. 1 is a front perspective view of a home appliance according to an embodiment. Referring to FIG. 1, a home appliance may include at least one of an oven 10 and a cooktop 20. In this embodiment, the home appliance is illustrated as being provided as a cooking appliance including the oven 10 and the cooktop 20. Hereinafter, structure of the home appliance will be described using a case in which the home appliance is the cooking appliance as an example.

The oven 10 may be formed in a shape including a substantially rectangular parallelepiped shape. Such an oven 10 may include a cavity that forms a frame of the oven 10. A cooking chamber may be defined inside of the cavity, and an opening that opens the cavity forward may be defined at a front surface of the cavity.

The cooking chamber may be formed in a shape of a hexahedron with an open front surface. The home appliance may cook food or other items (hereinafter, collectively “food”) by heating an internal space of the cooking chamber while such cooking chamber is shielded. That is, in the oven 10, the internal space of the cooking chamber is a space in which the food is actually cooked.

In the oven 10, a heater that heats the cooking chamber is disposed. As an example of such a heater, a broiler that heats the internal space of the cooking chamber from above may be disposed as the heater at an upper side of the cooking chamber.

Additionally, a bake heater that heats the internal space of the cooking chamber from below may also be disposed as the heater at a lower side of the cooking chamber. Additionally, a convection device that convects hot air to heat the internal space of the cooking chamber may be disposed as the heater at a rear side of the cooking chamber.

A door 15 that selectively opens and closes the cooking chamber may be pivotably disposed at a front portion of the main body 10. The door 15 may open and close the cooking chamber using a pull-down scheme in which an upper end thereof pivots in the vertical direction around a lower end thereof.

The door 15 may be formed in a shape of a hexahedron with a constant predetermined thickness. A handle 15a may be installed on a front surface of the door to be gripped when a user wants to pivot the door 15.

The cooktop 20 may be disposed on top of the oven 10. The cooktop 20 may be disposed to cook the food by heating the food or a container containing the food disposed in an open space, that is, at an upper side.

The cooktop 20 has a top plate 21 that forms a top surface outer appearance and supports the food to be cooked or the container containing the food. The food to be cooked or the container containing the food may be disposed on top of the top plate 21, and at least one heater 22 that heats the food to be cooked or the container containing the food may be located below the top plate 21.

The heater 22 may include an induction heating module that cooks the food by sending a current to a magnetic coil to generate an eddy current to heat the container itself, or may be formed in a shape that includes a radiant heating module that cooks the food with radiant heat generated by heating a heating coil. In addition, the heater 22 may include a hidden radiant burner that heats the top plate with a ceramic uniform burner that uses energy obtained from combustion of gas fuel, but uses radiant energy by the gas fuel rather than direct heat. In this embodiment, the heater 22 is illustrated as being the induction heating module having the coil for induction heating.

A control panel 100 may be disposed at an upper portion of a front surface of the home appliance. The control panel 100 may be disposed at an upper side of the oven 10 and at a front side of the cooktop 20, and may form a portion of a front surface outer appearance of the home appliance. A specific structure and operation of the control panel 100 will be described hereinafter.

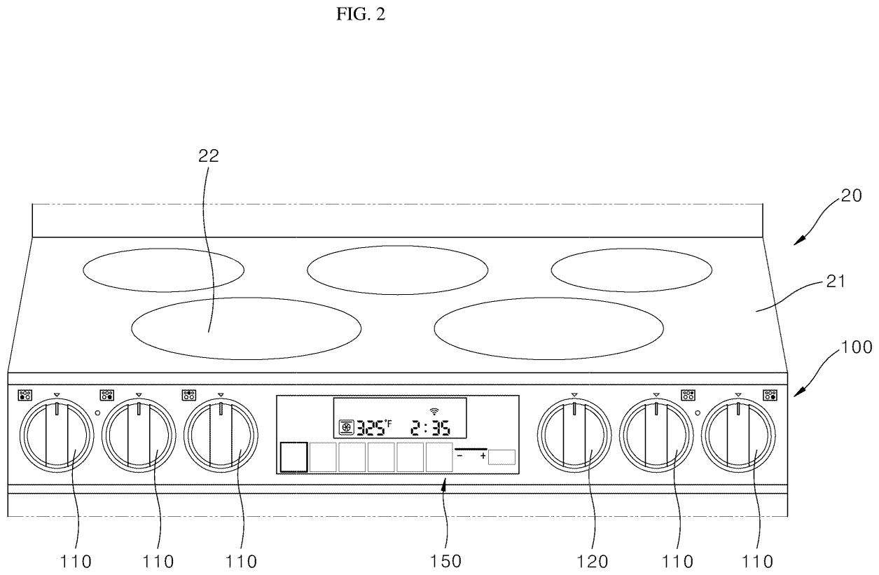

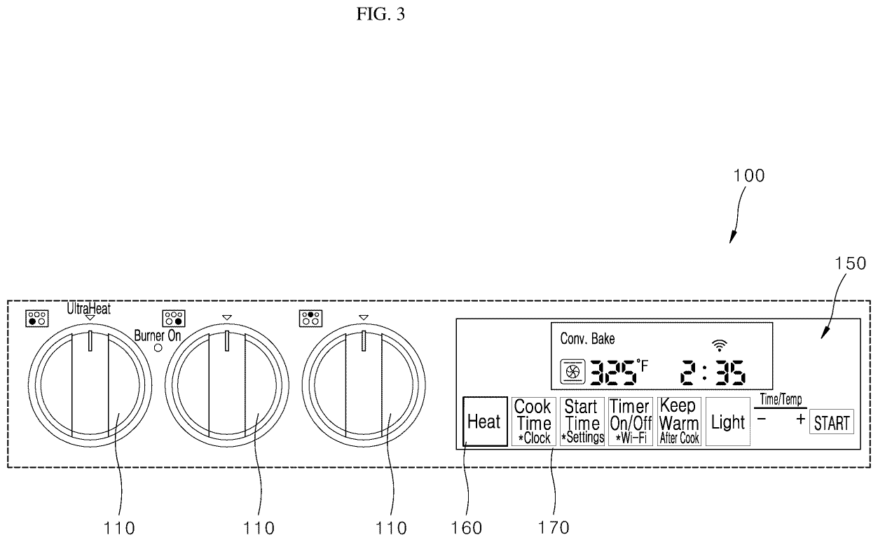

FIG. 2 is a front view showing a first example of a configuration of a control panel shown in FIG. 1 according to another embodiment. FIG. 3 is an enlarged view of a portion of the control panel shown in FIG. 2.

Referring to FIGS. 1 to 3, the control panel 100 may be disposed to adjust an operation of the home appliance and display an operating state of the home appliance. Such a control panel 100 may include a manipulator and a display 150.

The manipulator may be constructed to adjust the operation of the home appliance. Such a manipulator may include one or more knobs 110 and 120.

In this embodiment, it is illustrated that a plurality of knobs 110 and 120 is disposed on the manipulator. For example, the manipulator may include a plurality of knobs 110 that adjusts an operation of a plurality of heaters 22 disposed on the cooktop 20 and knob 120 that adjusts an operation of a heater disposed in the oven 10.

Each of the knobs 110 and 120 may be capable of turning. That is, each of the knobs 110 and 120 may be subjected to a turning manipulation. For example, each of the knobs 110 and 120 may be subjected to the turning manipulation and turned in the leftward and rightward or lateral direction.

Each of the knobs 110 and 120 may be configured to adjust a heating temperature of the heater 22 of the cooktop 20 or the heater of the oven 10. That is, a temperature of each heater 22 of the cooktop 20 or a heating temperature of the cooking chamber in the oven 10 may be set via manipulation of the knobs 110 and 120.

Additionally, the control panel 100 may include one or more switches 160 and 170 that adjusts the operation of the home appliance. The switches 160 and 170 may be disposed in the control panel 100 and be subjected to a pressing manipulation, unlike the knobs 110 and 120 that may be subjected to the turning manipulation.

In this embodiment, it is illustrated that the plurality of switches 160 and 170 are disposed in the control panel 100. For example, the plurality of switches 160 and 170 may include at least one of a switch that sets a cooking time, a timer setting switch, a lighting on/off switch, a cooking temperature setting switch, and/or a cooking start switch, for example.

In addition, the control panel 100 may further include the display 150. The display 150 may be configured to display an operating state of the home appliance and to adjust the operation of the home appliance. The display 150 may include a screen that displays the operating state of the home appliance.

In this embodiment, the display 150 is illustrated as being a touch screen with a touch panel connected to a display panel. Such a display 150 may display the screen showing the operating state of the home appliance and the plurality of switches 160 and 170 for adjusting the operation of the home appliance in the form of touch buttons. The user may touch at least one of the switches 160 and 170 displayed on the display 150 to adjust an operation of at least one of the home appliances.

As described above, the home appliance in this embodiment may have a plurality of heat sources. For example, the oven 10 may include the heater that heats the cooking chamber, and the cooktop 20 may include the plurality of heaters 22. In addition, the control panel 100 may include the plurality of knobs 110 and 120 and the plurality of switches 160 and 170 that adjusts operations of the above-mentioned heat sources.

Among those, the knob 110 related to the operation of the heater 22 of the cooktop 20 may be configured to adjust whether the heater 22 operates and the heating temperature. Such a knob 110 may be configured to be pressed and turned. That is, the knob 110 may be configured to be subjected to pressing and turning manipulations.

For example, the knob 110 may be configured to move in the first direction, that is, in the frontward and rearward direction. The knob 110 may be subjected to the pressing manipulation and move rearwards, and may be subjected to the turning manipulation and turn in the leftward and rightward or lateral direction about a first direction axis, that is, a frontward and rearward direction axis. When being subjected to the pressing and turning manipulations while the heater 22 is not operating, the knob 110 may generate a signal that allows the heater 22 to start operating, that is, a device operating signal.

The knob 110 may be moved by being pressed in the first direction, that is, rearwards, by the pressing manipulation, and in such state, may turn in the leftward and rightward or lateral direction to generate the device operating signal. Additionally, the heating temperature of the heater 22 may be adjusted by a degree of turning of the knob 110.

The plurality of switches 160 and 170 may be formed around the knob 110. In this embodiment, it is illustrated that the switches 160 and 170 are formed in a central area in the leftward and rightward or lateral direction of the control panel 100, and the knobs 110 and 120 are disposed on both sides of the switches 160 and 170 in the leftward and rightward or lateral direction.

As an example, the switches 160 and 170 may be formed in a shape of touch buttons in the display 150. As another example, the switches 160 and 170 may be formed in a shape of push buttons formed separately from the display 150. In this embodiment, the switches 160 and 170 formed in the shape of touch buttons in the display 150 are illustrated.

A knob setting switch 160 may be formed in the control panel 100. The knob setting switch 160 may be formed to be manipulated separately from the knob 110. Such a knob setting switch 160 may be subjected to pressing manipulation, and may generate a knob operating signal by being subjected to the pressing manipulation.

The knob setting switch 160 may be at least one of the plurality of switches 160 and 170 formed in the display 150. The knob setting switch 160 may be formed in a shape of a separate switch that independently generates only the knob operating signal, or may be formed in a shape of a switch having another function with the function of the knob setting switch added.

According to this embodiment, the knob setting switch 160 may be formed in a shape having a color or a mark that is not contained in the rest of the plurality of switches 160 and 170 excluding the knob setting switch 160. For example, the rest of the plurality of switches 160 and 170 excluding the knob setting switch 160 may be formed in a shape of touch buttons with a background color of the display 150, for example, black. In comparison, the knob setting switch 160 may be formed in a shape of a touch button whose background color is different from that of the display 150. Additionally, the knob setting switch 160 may be provided in a shape having a border displayed in a color different from the background color of the display 150.

The knob setting switch 160 formed as such may be easily seen among the plurality of switches 160 and 170. The knob setting switch 160 may reduce inconvenience experienced by the user in the process of operating the heater 22 by preventing the user from having difficulty in manipulating the knob setting switch 160 to operate the heater 22.

In one example, as described above, the knob 110 may move rearwards by being pressed in the first direction, that is, rearwards, and turn while being moved rearwards to generate the device operating signal. In addition, the knob setting switch 160 may also be pressed rearwards to generate the knob operating signal.

According to this embodiment, a location of the knob 110 in the first direction and a location of the knob setting switch 160 in the first direction may be set differently from each other. In this embodiment, the knob 110 is illustrated as being disposed forwardly of the knob setting switch 160.

Accordingly, a front end of the knob 110 may protrude forwardly of the knob setting switch 160. As the locations in the first direction of the knob 110 and the knob setting switch 160 are set as such, a possibility that the knob setting switch 160 is pressed together when the knob 110 is pressed becomes very low unless the user intends to press the knob 110 and the knob setting switch 160 together.

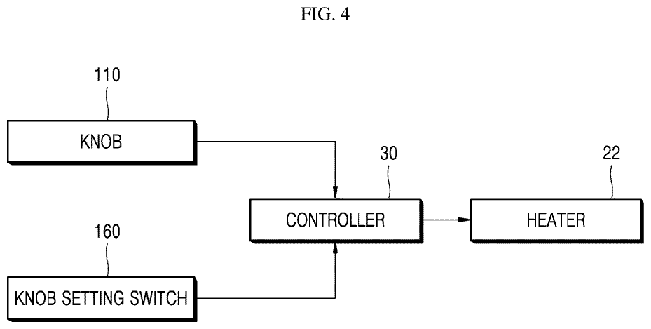

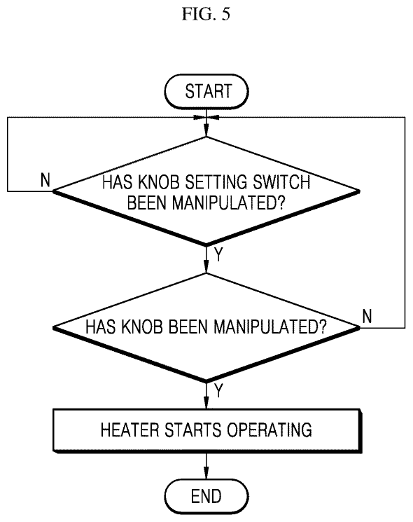

FIG. 4 is a schematic diagram of a home appliance according to an embodiment. FIG. 5 is a flowchart of an operation control process of a home appliance according to an embodiment.

Referring to FIGS. 3 to 5, when the user presses the knob setting switch 160, the knob setting switch 160 may generate the knob operating signal. The knob operating signal generated by the knob setting switch 160 may be transmitted to a controller 30. The controller 30, which has received the knob operating signal, may activate the operation of the knob 110 such that the knob 110 may generate the device operating signal.

When the user manipulates the knob 110 within a set or predetermined manipulation allowable period of time while the operation of the knob 110 is activated, the knob 110 may generate the device operating signal. For example, when the knob 110 is manipulated within 1 second after the knob setting switch 160 is manipulated, the knob 110 may generate the device operating signal.

The device operating signal generated by the knob 110 may be transmitted to the controller 30. The controller 30, which has received the device operating signal, may control the operation of the heater 22 such that the heater 22 generates heat.

As another example, the knob 110 may generate the device operating signal regardless of whether the device operating signal has been generated. In this case, the controller 30 may identify whether the device operating signal is also received by the controller 30 within the set manipulation allowable period of time after the knob operating signal is received by the controller 30. When it is confirmed that the device operating signal has also been received by the controller 30 within the set manipulation allowable period of time after the knob operating signal is received by the controller 30, the controller 30 may control the operation of the heater 22 such that the operation of the heater 22 starts.

According to this embodiment, for the user to operate the heater 22, the knob setting switch 160 must first be manipulated. The operation of the heater 22 may be started only when the user first presses the knob setting switch 160, then presses the knob 110, and then turns the knob 110. That is, the heater 22 may be operated only when the three manipulation steps of pressing the knob setting switch 160, then pressing the knob 110, and then turning the knob 110 are performed.

Typically, the knob is not manipulated only by intended manipulation of the user, and is also able to be manipulated by a user's mistake, or a child's play, for example. In other words, two-step manipulation of pressing and turning the knob may be performed by unintended manipulation of the user.

Therefore, when the operation of the heat source may be started by the two-step manipulation of pressing and then turning the knob, a dangerous situation in which the operation of the heater is started even by the unintended manipulation of the user, that is, the user's mistake or the child's play, may occur frequently.

In consideration of the above, the home appliance according to this embodiment provides a heater manipulating structure that requires the three-step manipulation of pressing the knob setting switch 160, then pressing the knob 110, and then turning the knob 110 to enable the operation of the heater 22. Accordingly, not only at least three operations must be performed for the heater 22 to start operating, but also at least two types of manipulation structures, that is, both of the knob 110 and the knob setting switch 160, must be manipulated for the heater 22 to start operating. As a result, unnecessary operation of the heater caused by the unintended manipulation of the user, that is, the user's mistake or the child's play, may be effectively prevented.

In addition, the knob 110 in this embodiment may be disposed forwardly of the knob setting switch 160. According to this embodiment, both the knob 110 and the knob setting switch 160 may be disposed on the front surface of the home appliance, and the front end of the knob 110 may be disposed to protrude forwardly of the knob setting switch 160.

As the knob 110 is disposed to protrude forwardly of the knob setting switch 160, the possibility that the knob 110 and the knob setting switch 160 are pressed together by the unintended manipulation of the user becomes very low. For example, even when the user accidentally presses the knob 110 with his or her body, it is very unlikely that the knob 110 and the knob setting switch 160 are pressed together by the body pressing the knob 110. In other words, in the home appliance according to this embodiment, both the knob 110 and the knob setting switch 160 must be manipulated for the heater 22 to start operating, and at the same time, the locations in the frontward and rearward direction of the knob 110 and the knob setting switch 160 are different from each other, so that the occurrence of the operation of the heater not intended by the user may be effectively suppressed. Such a home appliance according to this embodiment may significantly reduce power waste resulting from the unnecessary operation of the heater, a risk of fire or injury, for example.

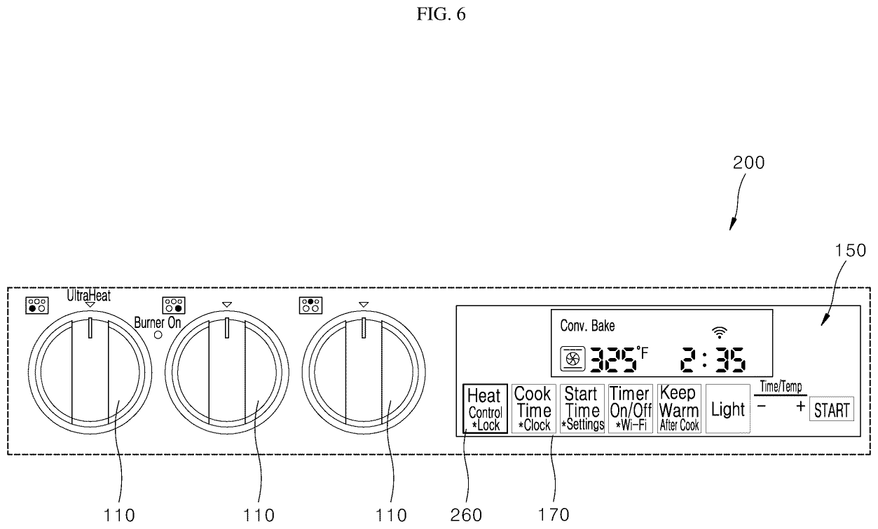

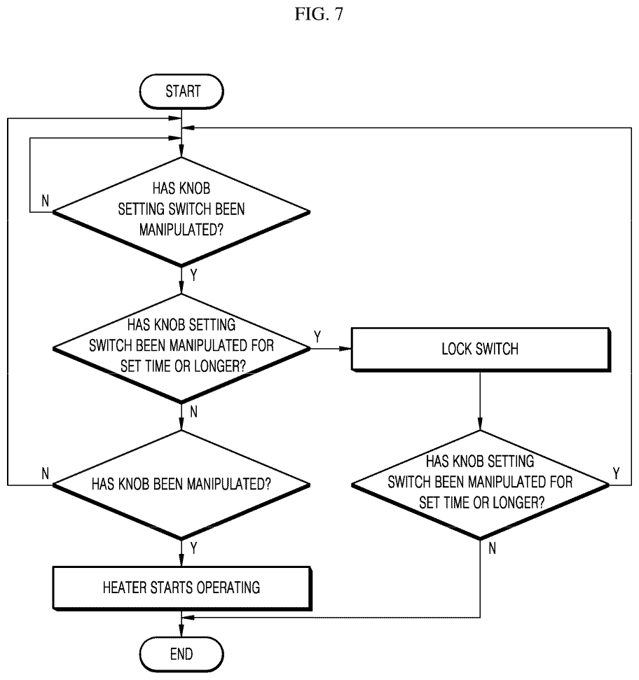

FIG. 6 is a front view of a control panel disposed in a home appliance according to another embodiment. FIG. 7 is a flowchart of an operation control process of a home appliance according to another embodiment.

Referring to FIGS. 6 and 7, a knob setting switch 260 according to this embodiment may be formed in a shape of a switch having a plurality of functions. In this embodiment, the knob setting switch 260 in a form in which the function of the knob setting switch is added to a switch having another function is illustrated.

According to this embodiment, the knob setting switch 260 may operate in one selected from a first operation or a second operation. When the knob setting switch 260 operates in the first operation, the knob setting switch 260 may generate the knob operating signal. When the knob setting switch 260 operates in the second operation, the knob setting switch 260 may generate a signal different from the knob operating signal.

Depending on a scheme by the knob setting switch 260 is pressed, one of the first operation or the second operation may be selected. For example, the operation of the knob setting switch 260 may be selected based on an amount of time the knob setting switch 260 is pressed.

Accordingly, when the knob setting switch 260 is pressed for less than a set or predetermined period of time, the knob setting switch 260 may operate in one of the first operation or the second operation. Alternatively, when the knob setting switch 260 is pressed for the set or predetermined period of time or longer, the knob setting switch 260 may operate in the other of the first operation or the second operation.

For example, when the knob setting switch 260 is pressed for less than 3 seconds, the knob setting switch 260 may operate in the first operation. When the knob setting switch 260 is pressed for 3 seconds or longer, the knob setting switch 260 may operate in the second operation.

As described above, in this embodiment, the knob setting switch may not be formed separately in the control panel 200, but the knob setting switch 260 may be provided in the form in which the function of the knob setting switch is added to the switch having another function.

That is, in this embodiment, the knob setting switch 260 may be provided in a form in which the function of the knob setting switch is added to one of the switches generally formed for setting the operation of the cooktop or the oven in the typical home appliance. According to this embodiment, when the knob setting switch 260 operates in the second operation, the knob setting switch 260 may generate a signal to block the operations of the plurality of switches 160 and 170.

For example, the knob setting switch 260 operating in the second operation may generate a signal to block operations of the rest of the switches 160 and 170 formed in the display 150 excluding the knob setting switch 260. In other words, the knob setting switch 260 operating in the second operation may generate a signal to execute a switch lock function that prevents the functions of the switches 160 and 170 formed in the control panel 200 from being activated.

When the knob setting switch 260 operates again in the second operation while the switch lock function is executed, the switch lock function is released. Accordingly, the functions of the switches 160 and 170 formed in the control panel 200 may be activated again.

Additionally, the knob setting switch 260 operating in the second operation as described above may generate a signal to block the knob 110 from generating the device operating signal. In this case, when the knob setting switch 260 operates in the second operation, a knob lock function that prevents the operation of the heater 22 from starting even when the knob 110 is subjected to the pressing and turning manipulations may be provided.

According to the home appliance according to this embodiment as described above, the knob lock function may be provided effectively with only the existing switches without a need to add a separate switch other than an input key generally formed to set the operation of the cooktop or the oven in the typical home appliance. Accordingly, not only a home appliance that may reliably prevent random operation of the heater while minimizing an increase in the number of components compared to that of the existing home appliance may be provided, but also a home appliance that is highly compatible with the existing cooking appliance may be provided.

In addition, the home appliance according to this embodiment eliminates the need to add the separate switch for providing the knob locking function, thereby suppressing a need to change an outer appearance design of the existing home appliance resulted from the addition of the switch.

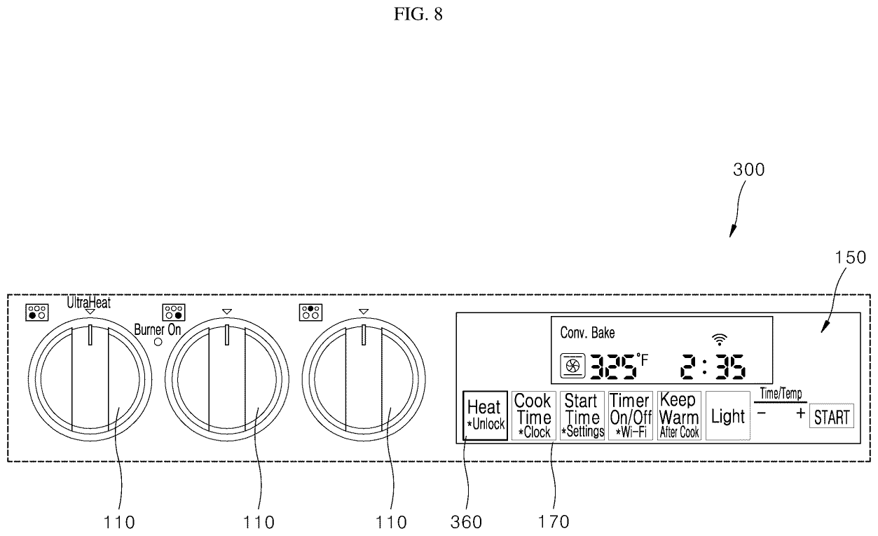

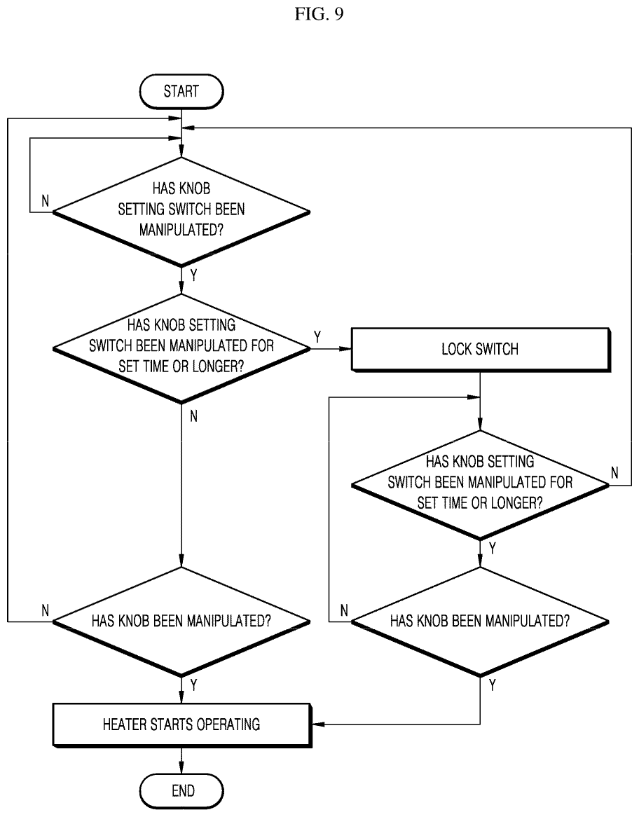

FIG. 8 is a front view of a control panel disposed in a home appliance according to yet another embodiment. FIG. 9 is a flowchart of an operation control process of a home appliance according to yet another embodiment.

Referring to FIGS. 8 and 9, a control panel 300 according to this embodiment may further include a setting release switch. The setting release switch may generate a signal to release the knob lock function, that is, a signal to enable the knob 110 to generate the device operating signal even when the knob operating signal is not generated.

For example, the setting release switch may be formed in a shape of a separate switch that independently generates only the signal to release the knob lock function, or may be formed in a shape of a switch with another function with the function of the set release switch added.

In this embodiment, a knob setting switch 360 in a form in which the function of the setting release switch is added to a switch having a knob setting switch function is illustrated. The knob setting switch 360, like the knob setting switch illustrated in the above-described embodiment, may operate in one selected among the first operation or the second operation. In other words, the knob setting switch 360 may generate the knob operating signal when operating in the first operation, and may generate a signal different from the knob operating signal when operating in the second operation.

According to this embodiment, when the knob setting switch 360 operates in the second operation, the knob setting switch 360 may generate the signal to release the knob lock function. Accordingly, the knob lock function may be released in the home appliance.

When the knob lock function is released in the home appliance, the knob 110 may generate the device operating signal even when the knob operating signal is not generated. That is, the heater may be operated via only the manipulation of the knob 110 without manipulation of the knob setting switch 360.

The home appliance in this embodiment including the knob setting switch 360 as described above may not only provide the knob lock function to prevent random unintentional operation of the heater, but also keep such function released when such a knob lock function is not necessary. In other words, the home appliance in the this embodiment may not only provide the function to prevent the random unintentional operation of the heater, but also provide a function that allows whether to use a door lock function to be selected depending on a need of the user.

Embodiments disclosed herein provide a manipulator with an improved structure such that an operation of a heat source caused by unintentional knob manipulation may be blocked, and a home appliance a manipulator.

In addition, embodiments disclosed herein provide a manipulator that may realize a knob lock function without adding a separate device or switch, and a home appliance including a manipulator.

A manipulator, and a home appliance including a manipulator according to one embodiment may include a knob that is turned to generate a device operating signal related to an operation of a home appliance, and a knob setting switch that is manipulated separately from the knob to generate a knob operating signal. The knob may be turned while the knob operating signal is generated to generate the device operating signal. Therefore, embodiments disclosed herein may effectively suppress an occurrence of an operation of a heater unintended by a user.

Additionally, a manipulator, and a home appliance including a manipulator according to another embodiment may include a knob that is subjected to a pressing manipulation and a turning manipulation, and a knob setting switch that is manipulated separately from the knob. When the manipulation of the knob setting switch and the pressing manipulation and the turning manipulation of the knob are all performed, an operation of a heat source may be started.

A manipulator according to one embodiment may include a knob that is turned to generate a device operating signal related to an operation of a home appliance, and a knob setting switch that is manipulated separately from the knob to generate a knob operating signal. The knob may be turned while the knob operating signal is generated to generate the device operating signal.

The home appliance may include one or more switches that are subjected to a pressing manipulation, and the knob setting switch may be at least one of the switches. The knob setting switch may operate in one selected among a first operation of generating the knob operating signal and a second operation of generating a signal different from the knob operating signal. One of the first operation and the second operation may be selected depending on a scheme of pressing the knob setting switch.

When the knob setting switch is pressed for less than a set or predetermined period of time, the knob setting switch may operate in one among the first operation and the second operation. When the knob setting switch is pressed for the set or predetermined period of time or longer, the knob setting switch may operate in the other among the first operation and the second operation.

The second operation may generate a signal to block an operation of the plurality of switches. The second operation may generate a signal to block the knob from generating the device operating signal. The second operation may generate a signal to enable the knob to generate the device operating signal even when the knob operating signal is not generated.

The manipulator may further include a plurality of switches that are subjected to a pressing manipulation, and the knob setting switch may be one of the plurality of switches. The knob setting switch may have a color or a mark not contained in the rest of the plurality of switches excluding the knob setting switch.

The manipulator may further include a setting release switch that generates a signal to enable the knob to generate the device operating signal even when the knob operating signal is not generated. The knob may be pressed and turned, and may be pressed and then turned while the knob operating signal is generated to generate the device operating signal.

The knob and the knob setting switch may be pressed in a first direction and move in the first direction. A location of the knob and a location of the knob setting switch may be set differently from each other with respect to the first direction.

The knob and the knob setting switch may be pressed and moved rearwards. The knob may be disposed forwardly of the knob setting switch.

A home appliance according to another embodiment includes a heat source that generates heat, and a manipulator that controls an operation of the heat source. A knob of the manipulator may be turned while a knob operating signal is generated to generate a device operating signal. The device operating signal may be a signal related to an operation of the heat source.

The manipulator may include a control panel that controls operation of the heat source. The control panel may include one or more switches that are subjected to a pressing manipulation, and the knob setting switch may be at least one of the one or more switches.

The control panel may further include a touch panel including one or more switches that are subjected to a pressing manipulation. The knob setting switch may be at least one of the one or more switches.

A home appliance according to still another embodiment may include a heat source that generates heat, a knob that is subjected to a pressing manipulation and a turning manipulation, and a knob setting switch that is manipulated separately from the knob. When both the pressing manipulation and the turning manipulation of the knob are performed while the knob setting switch is manipulated, a device operating signal related to an operation of the heat source may be generated.

The cooking appliance requires the manipulation of both the knob and the knob setting switch for the heater to start operating, and at the same time, allows locations in the frontward and rearward direction of the knob and the knob setting switch to be different from each other, so that the occurrence of the operation of the heater not intended by the user may be effectively suppressed.

Embodiments disclosed herein may significantly reduce power waste resulting from unnecessary operation of the heater, the risk of fire or injury, for example.

In addition, embodiments disclosed herein may not only provide a cooking appliance that may reliably prevent random operation of a heater while minimizing the increase in the number of components compared to that of existing home appliances, but also provide a cooking appliance that is highly compatible with existing cooking appliances.

Additionally, embodiments disclosed herein may eliminate the need to add a separate switch for providing the knob lock function, thereby suppressing the need to change the outer appearance design of existing cooking appliances resulting from the addition of the switch.

In addition, embodiments disclosed herein may not only provide the function to prevent the random unintentional operation of the heater, but also provide the function that allows whether to use the door lock function to be selected depending on the need of the user.

Embodiments have been described with reference to the embodiments shown in the drawings, but this is merely illustrative. Those skilled in the art will understand that various modifications and other equivalent embodiments are possible. Therefore, the true technical protection scope should be determined by the scope of the patent claims below.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” for example, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A manipulator, comprising:
at least one knob configured to be turned to generate a device operating signal related to an operation of a home appliance; and
a knob setting switch configured to be manipulated separately from the at least one knob to generate a knob operating signal, wherein if the at least one knob is turned while the knob operating signal is being generated, the least one knob is configured to generate the device operating signal.

2. The manipulator of claim 1, wherein the manipulator includes one or more switches configured to be subjected to a pressing manipulation, and wherein the knob setting switch is at least one of the one or more switches.

3. The manipulator of claim 2, wherein the knob setting switch operates in one of a first operation of generating the knob operating signal or a second operation of generating a signal different from the knob operating signal, and wherein one of the first operation or the second operation is selected depending on a scheme of pressing the knob setting switch.

4. The manipulator of claim 3, wherein when the knob setting switch is pressed for less than a predetermined period of time, the knob setting switch operates in one of the first operation or the second operation, and wherein when the knob setting switch is pressed for the predetermined period of time or longer, the knob setting switch operates in the other of the first operation or the second operation.

5. The manipulator of claim 3, wherein the second operation generates a signal to block an operation of the plurality of switches.

6. The manipulator of claim 3, wherein the second operation generates a signal to block the at least one knob from generating the device operating signal.

7. The manipulator of claim 3, wherein the second operation generates a signal to enable the at least one knob to generate the device operating signal even when the knob operating signal is not generated.

8. The manipulator of claim 1, further comprising a plurality of switches configured to be subjected to a pressing manipulation, wherein the knob setting switch is one of the plurality of switches, and wherein the knob setting switch has a color or a mark not contained in the rest of the plurality of switches excluding the knob setting switch.

9. The manipulator of claim 1, further comprising a setting release switch configured to generate a signal to enable the at least one knob to generate the device operating signal even when the knob operating signal is not generated.

10. The manipulator of claim 1, wherein the at least one knob is configured to be pressed and turned, and wherein if the at least one knob is pressed and then turned while the knob operating signal is being generated, the least one knob is configured to generate the device operating signal.

11. The manipulator of claim 10, wherein the at least one knob and the knob setting switch are pressed in a first direction, and wherein a location of the at least one knob and a location of the knob setting switch are set differently from each other with respect to the first direction.

12. The manipulator of claim 10, wherein the at least one knob and the knob setting switch are pressed rearwards, and wherein the at least one knob is disposed forwardly of the knob setting switch.

13. A home appliance comprising the manipulator of claim 1.

14. The home appliance of claim 13, further comprising at least one heat source configured to generate heat, wherein the device operating signal is a signal related to an operation of the at least one heat source.

15. The home appliance of claim 14, further comprising a control panel configured to control an operation of the at least one heat source, wherein the control panel includes one or more switches configured to be subjected to a pressing manipulation, and wherein the knob setting switch is at least one of the one or more switches.

16. The home appliance of claim 14, further comprising a control panel configured to control an operation of the at least one heat source, wherein the control panel further includes a touch panel including one or more switches configured to be subjected to a pressing manipulation, and wherein the knob setting switch is at least one of the one or more switches.

17. A home appliance, comprising:
at least one heat source configured to generate heat;
at least one knob configured to be subjected to a pressing manipulation and a turning manipulation; and
a knob setting switch configured to be manipulated separately from the at least one knob, wherein when both the pressing manipulation and the turning manipulation of the at least one knob are performed while the knob setting switch is manipulated, a device operating signal related to an operation of the at least one heat source is generated.

18. A home appliance, comprising:
a plurality of heat sources configured to generate heat;
a controller configured to control operations of the home appliance;
a manipulator including a plurality of knobs configured to be pressed and turned; and
a knob setting switch spaced apart from the at least one knob and configured to be pressed, wherein when the knob setting switch is pressed, the knob setting switch sends a knob operating signal to the controller and the controller activates operation of the plurality of knobs, and if one of the plurality of knobs is pressed and turned while the knob operating signal is being generated, the one of the plurality of knobs is configured to send a device operating signal to a corresponding one of the plurality of heat sources.

19. The home appliance of claim 18, wherein the plurality of knobs and the knob setting switch are pressed in a first direction, and wherein the plurality of knobs is disposed forwardly of the knob setting switch.

20. The home appliance of claim 18, further comprising a control panel having a display, wherein the knob setting switch is formed on the display.
